(19) United States
(12) Patent Application Publication
(10) Pub. No.: US 2018/0007263 A1
(43) Pub. Date: Jan. 4, 2018

(54) METHOD AND APPARATUS FOR AUTOMATED PLACEMENT OF A SEAM IN A PANORAMIC IMAGE DERIVED FROM MULTIPLE CAMERAS

(71) Applicant: Nokia Technologies Oy, Espoo (FI)

(72) Inventors: Basavaraja Vandrotti, San Jose, CA (US); Hoseok Chang, Sunnyvale, CA (US); Per-Ola Robertsson, Sunnyvale, CA (US); Devon Copley, Sunnyvale, CA (US); Maneli Noorkami, Sunnyvale, CA (US); Hui Zhou, Sunnyvale, CA (US)

(21) Appl. No.: 15/637,132

(22) Filed: Jun. 29, 2017

Related U.S. Application Data
(60) Provisional application No. 62/356,355, filed on Jun. 29, 2016.

(51) Int. Cl. H04N 5/232; H04N 5/225; G06K 9/46; G06T 3/40

(52) U.S. Cl. CPC H04N 5/23238; G06T 3/4038; H04N 5/2258; G06K 9/4609; G06T 2207/20221; G06T 2200/32

(57) ABSTRACT

A method, apparatus and computer program product are provided to generate a panoramic view derived from multiple cameras and automatically place a seam in that panoramic view in a computationally efficient manner. In regards to a method, images captured by at least two cameras are received. Each camera has a different, but partially overlapping field of view. The method determines a seam location and scale factor to be used when combining the images together to minimize errors at the seam between the two images. In some example implementations, the seam location and scale factor may be recalculated in response to a manual or automatic trigger. In some additional example implementations, motion associated with an image element near a seam location is detected, and the seam location is moved in a direction opposite that of the direction of motion.

### CROSS-REFERENCE TO RELATED APPLICATIONS

The present application claims the benefit of U.S. Provisional Patent Application Ser. No. 62/356,355 which was filed on Jun. 29, 2016 and titled METHODS AND APPARATUS FOR AUTOMATED PLACEMENT OF A SEAM IN A PANORAMIC IMAGE DERIVED FROM MULTIPLE CAMERAS, the entire content of which is incorporated by reference herein for all purposes.

### TECHNICAL FIELD

An example embodiment relates generally to image processing, including the capture and delivery of panoramic images and videos, including combining images captured by multiple cameras into a panoramic image, such as a 360° panorama.

### BACKGROUND

Panoramic views, including 360° images and videos, are generated for a variety of purposes. For example, panoramic views may be utilized in conjunction with various immersive media applications, such as virtual reality systems. In such a virtual reality system, a viewer, such as a person viewing a head mounted display, may be presented a panoramic view that presents content across a wider field of view than that offered by conventional video viewing systems that present content across a narrow field of view. As such, and particularly in contexts where a 360° view is presented, the viewer may be more fully immersed in the scene represented by the panoramic view.

A panoramic view, such as a 360° image or video, may be captured using a plurality of cameras, such as planar sensors with fisheye lenses, where the nodal point of each camera differs from camera to camera. Consequently, individual images captured by the various cameras typically contain parallax differentials and other differences that pose difficulties when attempting to combine multiple images into a single, 360° image or video.

The combination of individual images to form the panoramic image may be both processing intensive and time intensive. For example, currently available commercial solutions, such as the Google Jump system, rely on computational photography techniques that involve extensive processor resources, offline processing, or both to combine multiple images captured by a plurality of cameras into a single 360° image. As such, the availability of the resulting panoramic view is delayed by the requisite processing of the images, such that the panoramic image cannot be viewed in real time. Moreover, systems that require extensive image processing and the associated hardware necessary to perform such image processing to combine and blend the images captured by a plurality of cameras are of limited utility in many situations.

### BRIEF SUMMARY

A method, apparatus and computer program product are therefore provided in accordance with an example embodiment in order to automatically place the seam between combined images used to generate a panoramic view, such as for utilization in conjunction with a virtual reality system, in a computationally efficient manner. In this regard, the method, apparatus and computer program product of an example embodiment provide for the selection of seam locations and scale factors used when combining adjacent images with overlapping portions in a more timely manner and with less intensive processing than at least some conventional systems. Thus, the resulting panoramic view may be more readily available and may be more widely utilized, such as by viewers of virtual reality systems, particularly in contexts where real time and/or near real time rendering of panoramic video views is desired.

In an example embodiment, a method is provided that includes receiving an image frame captured by a first camera and an image frame captured by a second camera, wherein the first camera and the second camera have different fields of view, wherein the different fields of view have a mutually overlapping portion. The method of this example embodiment also includes combining the image frame captured by the first camera and the image frame captured by the second camera into a composite image. The method of this example embodiment also includes determining a seam location and a scale factor for the image frame captured by the first camera and the image frame captured by the second camera. The method of this example embodiment also includes applying the seam location and the scale factor to a plurality of subsequent image frames captured by the first camera and a plurality of subsequent image frames captured by the second camera

In some implementations of the method of an example embodiment, determining a seam location and a scale factor includes generating a plurality of scaled image frames by applying a plurality of scale factors to the image frame captured by at least one of the first camera or the second camera; computing an error measurement associated with the seam location for each scaled image frame from amongst the plurality of scaled image frames; and identifying the scale factor based upon the computed error measurement.

In some implementations of the method of an example embodiment, determining a seam location and a scale factor includes generating a plurality of scaled image frames by applying a plurality of scale factors to the image frame captured by at least one of the first camera or the second camera; dividing the mutually overlapping portion of the fields of view of the image frame captured by the first camera and the image frame captured by the second camera into a plurality of overlapping sections; computing an error measurement associated with each overlapping section of each scaled image frame from amongst the plurality of scaled image frames; and identifying the section and the scale factor based upon the computed error measurement.

In some implementations of the method of an example embodiment, the method also includes receiving a control signal associated with a trigger for determining a second seam location and a second scale factor for a second image frame captured by the first camera and a second image frame captured by the second camera and, in response to receiving the control signal, determining the second seam location and the second scale factor for the second image frame captured by the first camera and the second image frame captured by the second camera; and applying the second seam location and the second scale factor to a second plurality of subsequent image frames captured by the first camera and a second plurality of subsequent image frames captured by the second camera.

In some implementations of the method of an example embodiment, the method also includes detecting a set of data associated with motion of an image element, wherein the image element is located within a predetermined distance of the seam location. In some such implementations, the method also includes, in response to detecting the set of data associated with motion of the image element, determining a direction associated with the motion. In some such implementations, the method further includes shifting the seam location in a direction opposite the direction associated with the motion.

In another example embodiment, an apparatus is provided that includes at least one processor and at least one memory that includes computer program code with the at least one memory and the computer program code configured to, with the at least one processor, cause the apparatus to at least receive an image frame captured by a first camera and an image frame captured by a second camera, wherein the first camera and the second camera have different fields of view, wherein the different fields of view have a mutually overlapping portion; combine the image frame captured by the first camera and the image frame captured by the second camera into a composite image; determine a seam location and a scale factor for the image frame captured by the first camera and the image frame captured by the second camera; and apply the seam location and the scale factor to a plurality of subsequent image frames captured by the first camera and a plurality of subsequent image frames captured by the second camera.

In some implementations of the apparatus of an example embodiment, the at least one memory and the computer program code are configured to, with the processor, cause the apparatus to determine a seam location and a scale factor by generating a plurality of scaled image frames by applying a plurality of scale factors to the image frame captured by at least one of the first camera or the second camera; computing an error measurement associated with the seam location for each scaled image frame from amongst the plurality of scaled image frames; and identifying the scale factor based upon the computed error measurement.

In some implementations of the apparatus of an example embodiment, the at least one memory and the computer program code are configured to, with the processor, cause the apparatus to determine a seam location and a scale factor by generating a plurality of scaled image frames by applying a plurality of scale factors to the image frame captured by at least one of the first camera or the second camera; dividing the mutually overlapping portion of the fields of view of the image frame captured by the first camera and the image frame captured by the second camera into a plurality of overlapping sections; computing an error measurement associated with each overlapping section of each scaled image frame from amongst the plurality of scaled image frames; and identifying the section and the scale factor based upon the computed error measurement.

In some implementations of the apparatus of an example embodiment, the at least one memory and the computer program code are configured to, with the processor, cause the apparatus to receive a control signal associated with a trigger for determining a second seam location and a second scale factor for a second image frame captured by the first camera and a second image frame captured by the second camera and, in response to receiving the control signal, determine the second seam location and the second scale factor for the second image frame captured by the first camera and the second image frame captured by the second camera; and apply the second seam location and the second scale factor to a second plurality of subsequent image frames captured by the first camera and a second plurality of subsequent image frames captured by the second camera.

In some implementations of the apparatus of an example embodiment, the at least one memory and the computer program code are configured to, with the processor, cause the apparatus to detect a set of data associated with motion of an image element, wherein the image element is located within a predetermined distance of the seam location. In some such implementations, the at least one memory and the computer program code are configured to, with the processor, cause the apparatus to, in response to detecting the set of data associated with motion of the image element, determine a direction associated with the motion. In some such implementations, the at least one memory and the computer program code are configured to, with the processor, cause the apparatus to shift the seam location in a direction opposite the direction associated with the motion.

In a further example embodiment, a computer program product is provided that includes at least one non-transitory computer-readable storage medium having computer-executable program code instructions stored therein with the computer-executable program code instructions including program code instructions configured to receive an image frame captured by a first camera and an image frame captured by a second camera, wherein the first camera and the second camera have different fields of view, wherein the different fields of view have a mutually overlapping portion; combine the image frame captured by the first camera and the image frame captured by the second camera into a composite image; determine a seam location and a scale factor for the image frame captured by the first camera and the image frame captured by the second camera; and apply the seam location and the scale factor to a plurality of subsequent image frames captured by the first camera and a plurality of subsequent image frames captured by the second camera.

In an implementation of the computer-executable program code instructions of an example embodiment, the program code instructions configured to determine a seam location and a scale factor include program code instructions configured to generate a plurality of scaled image frames by applying a plurality of scale factors to the image frame captured by at least one of the first camera or the second camera; compute an error measurement associated with the seam location for each scaled image frame from amongst the plurality of scaled image frames; and identify the scale factor based upon the computed error measurement.

In another implementation of the computer-executable program code instruction of an example embodiment, the program code instructions configured to determine a seam location and a scale factor comprise program code instructions configured to generate a plurality of scaled image frames by applying a plurality of scale factors to the image frame captured by at least one of the first camera or the second camera; divide the mutually overlapping portion of the fields of view of the image frame captured by the first camera and the image frame captured by the second camera into a plurality of overlapping sections; compute an error measurement associated with each overlapping section of each scaled image frame from amongst the plurality of scaled image frames; and identify the section and the scale factor based upon the computed error measurement.

In an implementation of the computer-executable program code instructions of an example embodiment, the computer-executable program code instructions further comprise program code instructions configured to receive a control signal associated with a trigger for determining a second seam location and a second scale factor for a second image frame captured by the first camera and a second image frame captured by the second camera and, in response to receiving the control signal, determine the second seam location and the second scale factor for the second image frame captured by the first camera and the second image frame captured by the second camera; and apply the second seam location and the second scale factor to a second plurality of subsequent image frames captured by the first camera and a second plurality of subsequent image frames captured by the second camera.

In an implementation of the computer-executable program code instructions of an example embodiment, the computer-executable program code instructions further comprise program code instructions configured to detect a set of data associated with motion of an image element, wherein the image element is located within a predetermined distance of the seam location. In some such implementations, the computer-executable program code instructions further comprise program code instructions configured to, in response to detecting the set of data associated with motion of the image element, determine a direction associated with the motion; and shift the seam location in a direction opposite the direction associated with the motion.

In yet another example embodiment, an apparatus is provided that includes means for receiving an image frame captured by a first camera and an image frame captured by a second camera, wherein the first camera and the second camera have different fields of view, wherein the different fields of view have a mutually overlapping portion; combining the image frame captured by the first camera and the image frame captured by the second camera into a composite image; determining a seam location and a scale factor for the image frame captured by the first camera and the image frame captured by the second camera; and applying the seam location and the scale factor to a plurality of subsequent image frames captured by the first camera and a plurality of subsequent image frames captured by the second camera.

In an implementation of the apparatus of an example embodiment, the apparatus further includes means for determining a plurality of scaled image frames by applying a plurality of scale factors to the image frame captured by at least one of the first camera or the second camera; computing an error measurement associated with the seam location for each scaled image frame from amongst the plurality of scaled image frames; and identifying the scale factor based upon the computed error measurement.

In another implementation of the apparatus of an example embodiment, the apparatus further includes means for determining a plurality of scaled image frames by applying a plurality of scale factors to the image frame captured by at least one of the first camera or the second camera; dividing the mutually overlapping portion of the fields of view of the image frame captured by the first camera and the image frame captured by the second camera into a plurality of overlapping sections; computing an error measurement associated with each overlapping section of each scaled image frame from amongst the plurality of scaled image frames; and identifying the section and the scale factor based upon the computed error measurement.

In an implementation of the apparatus of an example embodiment, the apparatus further includes means for receiving a control signal associated with a trigger for determining a second seam location and a second scale factor for a second image frame captured by the first camera and a second image frame captured by the second camera and, in response to receiving the control signal, determining the second seam location and the second scale factor for the second image frame captured by the first camera and the second image frame captured by the second camera; and applying the second seam location and the second scale factor to a second plurality of subsequent image frames captured by the first camera and a second plurality of subsequent image frames captured by the second camera.

In an implementation of the apparatus of an example embodiment, the apparatus further includes means for detecting a set of data associated with motion of an image element, wherein the image element is located within a predetermined distance of the seam location. In some such implementations, the apparatus further includes means for, in response to detecting the set of data associated with motion of the image element, determining a direction associated with the motion. In some such implementations, the apparatus further includes means for shifting the seam location in a direction opposite the direction associated with the motion.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts the respective fields of view of first and second cameras configured to capture images that are processed in accordance with an example embodiment of the present invention;

FIG. 2 is a block diagram of an apparatus that may be specifically configured in accordance with an example embodiment of the present invention;

FIG. 3 is a flowchart illustrating the operations performed, such as by the apparatus of FIG. 2, in accordance with an example embodiment of the present invention;

FIG. 4 illustrates some of the considerations associated with the application of scale factors to images in accordance with an example embodiment of the present invention;

FIG. 5 is a flowchart illustrating another set of operations performed, such as by the apparatus of FIG. 2, in accordance with an example embodiment of the present invention; and

FIG. 6 is a flowchart illustrating another set of operations performed, such as by the apparatus of FIG. 2, in accordance with an example embodiment of the present invention;

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to efficiently generate a panoramic view, such as for use in conjunction with virtual reality or other applications. In this regard, a panoramic view is generated by combining images captured by a plurality of cameras arranged in an array, such that portions of images captured by adjacent cameras within the array overlap with each other and may be stitched or otherwise combined together. Through the application of several techniques, the coordination between two adjacent images can be improved, resulting in an enhanced viewing experience for a viewer. Moreover, the panoramic view may be generated in an efficient manner, both in terms of the processing resources consumed during the generation of the panoramic view and the time required to generate the panoramic view. As a result, the panoramic view may, in some instances, be generated in real time or near real time relative to the capture of the images that at least partially comprise the panoramic view.

In some example implementations, the coordination of two adjacent images is achieved by searching a two-dimensional space of possible options to identify a configuration of seam location, scale factor, or both, that results in a minimum error for a given frame. In some contexts, including but not limited to contexts where the location of a seam between two adjacent images is fixed, a variety of convergence depths between two adjacent cameras are evaluated by applying a plurality of scale factors to an image and calculating an error associated with each scale factor. The scale factor associated with the minimum error is then selected, and applied to subsequent frames captured by the particular adjacent cameras. In some contexts, including but not limited to contexts where the location of a seam between two adjacent images is not fixed, the overlapping area of images captured by the adjacent cameras is divided into a series of columns or other sections, and an error associated with each column is calculated. The column or other section with the minimum error is then selected as the seam location, and applied to subsequent frames captured by the particular adjacent cameras. In some contexts, including but not limited to contexts where motion is detected in content near a seam location, the seam location can be moved on a per-frame basis in response to the motion. Regardless of the context in which the seam location and/or scale factor is selected and applied, the selection and application of a seam location and/or scale factor may be performed and/or re-performed in response to a manual and/or automatic trigger.

Some example implementations contemplate the use of devices suitable for capturing images used in virtual reality and other immersive content environments, such as Nokia's OZO system, where multiple cameras are placed in an array such that each camera is aimed in a particular direction to capture a particular field of view. Particularly in contexts involving live stitching, it is necessary to stitch the images received from each camera in real time or near real time. In such a scenario, solutions for real time or near real time stitching involve the use of camera calibration data. The camera calibration data can be used to generally determine the placement of each camera, and generate a transformation matrix that can be used to stitch multiple images together to form a panoramic view, such as a 360° image. Camera calibration is typically performed in a manner directed toward infinite scene location. As a result, objects located relatively near the camera(s) will be subject to parallax effects, which compound the difficulty associated with stitching the images together. While such stitching may be accomplished using time-intensive and processor-resource intensive techniques, such techniques are incompatible with the timing requirements associated with live stitching and/or other practical considerations associated with the camera array and its processing capabilities. In contrast, the techniques disclosed herein are viable in live stitching contexts, particularly in resource-constrained situations. Moreover, implementations of the techniques disclosed herein have provided for a significant reduction of visible stitching errors under a wider range of input than conventional techniques used to achieve real time or near real time performance at typical resolutions on reasonable hardware.

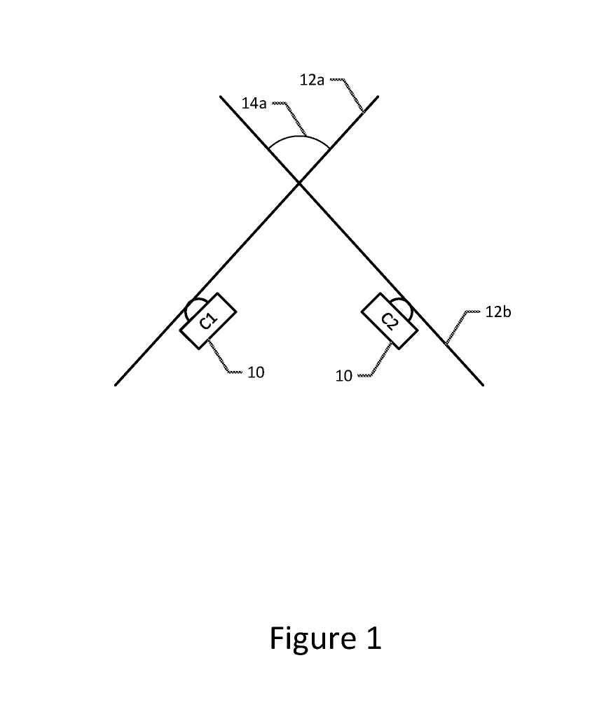

The panoramic view that is generated in accordance with an example embodiment of the present invention is based upon images captured by at least two cameras. In the embodiment depicted in FIG. 1, the two cameras 10 include a first camera C1 and a second camera C2. However, in other embodiments, images may be captured by more than two cameras, such as three or more cameras, and then combined to generate a panoramic image. For example, cameras C1 and C2 may be included as a part of a plurality of cameras C1, C2, C3, C4, . . . , Cₙ. Moreover, the plurality of cameras may be arranged such that images captured by C1 and C2 have mutually overlapping portions, images captured by C2 and C3 have mutually overlapping portions, images captured by C3 and C4 have mutually overlapping portions, and images captured by Cₙ and C1 have mutually overlapping portions, such that when the images are combined, a 360° view is created. A variety of different types of cameras having different fields of view may be utilized in order to capture the images that are utilized to generate the panoramic view. In the example embodiment described herein with respect to FIG. 1, however, each of the cameras is a fisheye camera having a 180° field of view. Moreover, while each of the cameras may be the same type of camera and may have a field of view that extends over the same angular range, such as 180°, the cameras may differ from one another and may have different fields of view in other embodiments. For example, one or more of the cameras may have a field of view greater than 180°, such as a 195° field of view, or a field of view less than 180°.

As shown in FIG. 1, the cameras 10 are positioned so as to have different fields of view. However, the fields of view of the at least two cameras have a mutually overlapping portion. In the embodiment illustrated in FIG. 1, for example, the first camera C1 has a 180° field of view as represented by line 12a. Similarly, the second camera C2 has a 180° field of view as represented by line 12b. As shown in the embodiment of FIG. 1, the fields of view of each of the cameras differ from one another, but share a mutually overlapping portion. In this regard, the fields of view of the first and second cameras overlap in the region designated 14a in FIG. 1.

While the embodiment depicted in FIG. 1 shows the cameras 10 as being arranged in a symmetrical relationship such that the first camera C1 and the second camera C2 are disposed at the same angle and spaced by the same distance from the overlapping portion of their respective field of view, the cameras may be differently positioned and oriented in other embodiments.

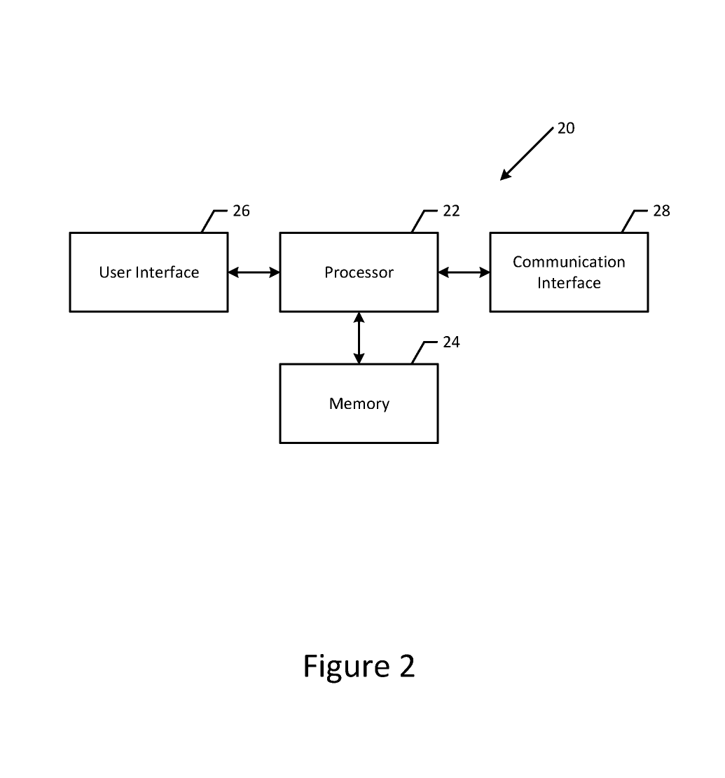

Based upon the images captured by the cameras 10, a panoramic view is generated. In this regard, the panoramic view may be generated by an apparatus 20 as depicted in FIG. 2. The apparatus may be embodied by one of the cameras or may be distributed between the cameras. Alternatively, the apparatus 20 may be embodied by another computing device, external from the cameras. For example, the apparatus may be embodied by a personal computer, a computer workstation, a server or the like, or by any of various mobile computing devices, such as a mobile terminal, e.g., a smartphone, a tablet computer, a video game player, etc. Alternatively, the apparatus may be embodied by a virtual reality system, such as a head mounted display.

Regardless of the manner in which the apparatus 20 is embodied, the apparatus of an example embodiment is configured to include or otherwise be in communication with a processor 22 and a memory device 24 and optionally the user interface 26 and/or a communication interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 20 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 20 may optionally include a user interface 26 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

The apparatus 20 may optionally also include the communication interface 28. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

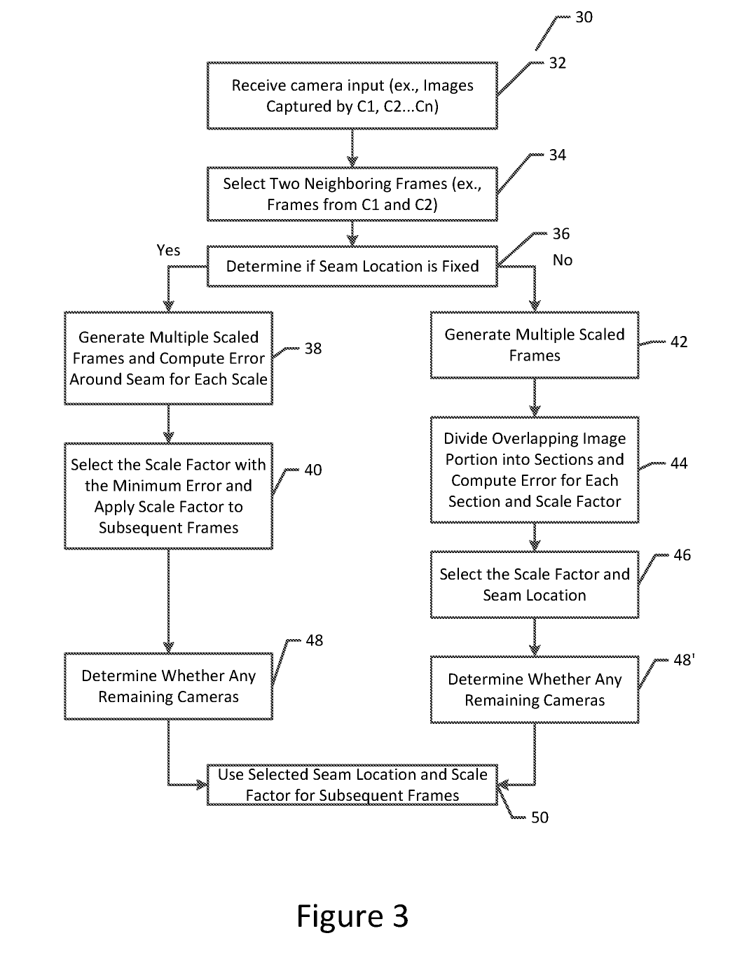

Referring now to FIG. 3, the operations performed by the apparatus 20 of FIG. 2 in accordance with an example embodiment of the present invention are depicted as a process flow 30. In this regard, the apparatus includes means, such as the processor 22, the memory 24, the communication interface 28 or the like, for receiving images captured by the at least two cameras 10. As described above, each camera has a different field of view and the fields of view of the at least two cameras have a mutually overlapping portion. The images captured by the cameras may be received by the apparatus directly from the cameras, such as via the communication interface. Alternatively, the images captured by the cameras may be stored, such as in the memory 24 or in an external memory, and may thereafter be received by the apparatus following storage.

The apparatus includes means, such as the processor 22, the memory 24, the communication interface 28 or the like, for receiving an image frame captured by a first camera and an image frame captured by a second camera, wherein the first camera and the second camera have different fields of view, wherein the different fields of view have a mutually overlapping portion. For example, and with reference to block 32 of FIG. 3, first image frames from a plurality of cameras are received by the apparatus 20. Some example implementations of block 32 contemplate receiving a series of images captured by a plurality of cameras, such as a video stream, including but not limited to a video stream associated with the live event, such as a concert or sporting event, such that the first image frames may be captured chronologically before subsequent sets of image frames. However, in some example implementations of block 32, the first images frames received need not be captured in any particular chronological order or representative of events that occurred in any particular chronological order with respect to subsequently received and/or processed frames.

The apparatus also includes means, such as the processor 22, the memory 24, the communication interface 28 or the like, for combining the image frame captured by the first camera and the image frame captured by the second camera into a composite image. For example, and with reference to block 34 of FIG. 3, the apparatus 20 of an example embodiment may combine an image frame captured by the first camera and the image frame captured by the second camera by selecting two neighboring frames from amongst the first set of frames and combining the images together. As described above with respect to FIG. 1 and the cameras C1 and C2 shown therein, the images captured by C1 and C2 contain mutually overlapping portions, such that the captured images can be combined to create a panoramic image that can depict a wider field of view than the field of view depicted in an image captured by C1 or C2 alone.

When the neighboring images are selected and combined, such as in example implementations of block 34, differences between the images in their mutually overlapping portions may be visible to a viewer and/or otherwise undesirable. Consequently, establishing and positioning a seam between the two images that minimizes such differences is desirable, and can improve the experience of a viewer, particularly a viewer who is seeking an immersive experience associated with a virtual reality viewing system. In some contexts, the seam established between two neighboring images will be fixed in a predetermined position with respect to the images for all such neighboring frames. However, in other contexts, the location of the seam will not be fixed in a particular location for all neighboring frames, and can be set, such as by apparatus 20, on a frame-by-frame basis or in accordance with any other protocol. Regardless of whether the seam is in a fixed location or not, the seam itself may take any of a number of configurations. For example, a seam may be configured as a vertical line. In other examples the seam may take the form of an arc or any other shape, including but not limited to an optimized shape.

The apparatus 20 also includes means, such as the processor 22, the memory 24, the communication interface 28 or the like, for determining a seam location and a scale factor for the image frame captured by the first camera and the image frame captured by the second camera. For example, and with reference to FIG. 3, particularly with respect to block 36 and blocks 38-50, the approach taken to determining a seam location and a scale factor for the neighboring frames differs in many example implementations based at least in part on whether the seam location is fixed or not. In example implementations where the seam location is fixed for the neighboring frames, that seam location and/or an indication that the seam location is fixed may be received and applied via the communication interface 28 and the processor 22, or retrieved and applied via the memory 24 and the processor 22 to the neighboring frames. In example implementations where the seam location is not fixed, the apparatus also includes means, such as the processor 22, the memory 24, the communication interface 28, or the like, for receiving an indication that the seam location is not fixed and determining a seam location.

In some example implementations, the apparatus 20 also includes means, such as the processor 22, memory 24, the communication interface 28, or the like, for generating a plurality of scaled image frames by applying a plurality of scale factors to the image frame captured by at least one of the first camera or the second camera. For example, and with reference to block 38 of FIG. 3, in contexts where the seam location is fixed, the apparatus 20 also includes means, such as the processor 22, memory 24, the communication interface 28, or the like, for determining a scale factor for the neighboring frames by at least generating a plurality of scaled frame images and computing an error around the seam area for each scaled image. In some example implementations, the apparatus generates a plurality of scaled frame images by applying multiple scale factors to an image frame captured by at least one of the cameras associated with the neighboring images.

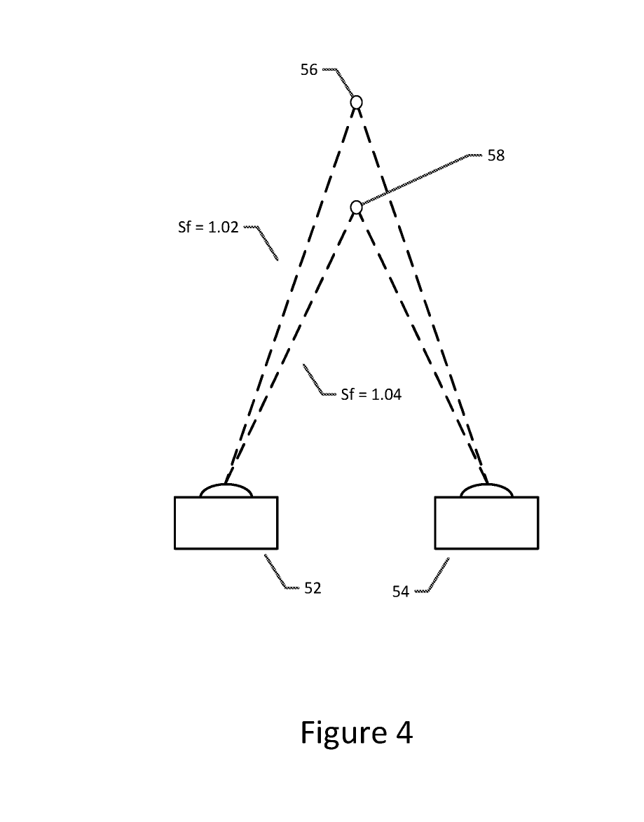

FIG. 4 presents a block diagram depicting an example environment illustrating the effect of applying one or more scale factors to one of a pair of neighboring images. As shown in FIG. 4, camera 52 and camera 54 are arranged in an array (with additional optional cameras omitted for clarity) such that an image captured by camera 52 has an overlapping portion with an image captured by camera 54. Camera 52 and/or camera 54 may take the form and orientation of any camera discussed or contemplated herein, including but not limited to those referenced with respect to FIG. 1 or elsewhere in this disclosure, including but not limited to cameras equipped with fisheye lenses and configured to capture a 195° field of view.

While camera 52 and camera 54 are arranged such that there is an overlapping portion of their respective fields of view and the images captured by camera 52 and camera 54 have mutually overlapping portions, the orientation and/or configuration of camera 52 and/or camera 54 may be such that the appearance of image elements common to images captured by camera 52 and camera 54 may be subject to parallax, differences in size, and other visibly perceptible differences. As shown in FIG. 4, multiple scale factors may be applied to at least camera 54 to adjust the location of the convergence point of camera 52 and camera 54. In the example depicted in FIG. 4, a scaling factor of 1.02 results in the convergence point being located at point 56, while scaling factor of 1.04 results in the convergence point being located at point 58. It will be appreciated that, in the interest of clarity, FIG. 4 is not necessarily drawn to scale. Moreover, it will be appreciated that the scale factors and convergence points depicted in FIG. 4 are merely examples, and any of a number of other scale factors, ranges of scale factors, and/or differences between scale factors may be used when scaling an image, depending on the context and implementation details associated with the scaling of an image.

With reference again to block 38 in FIG. 3, the apparatus also includes means, such as the processor 22, memory 24, the communication interface 28, or the like, for computing an error measurement associated with the seam location for each scaled image frame from amongst the plurality of scaled image frames. For example, and with reference to block 38 of FIG. 3, some example implementations of block 38 involve computing an error measurement by calculating the sum of the absolute differences of pixels and/or pixel values between the neighboring image frames for each scaled image. However, any error metric or other approach to computing an error associated with the seam area of a scaled image with respect to an adjacent image may be used.

The apparatus 20 also includes means, such as the processor 22, memory 24, the communication interface 28, or the like, for identifying the scale factor based upon the computed error measurement. For example, and with reference to blocks 38 and 40 of FIG. 3, example implementations contemplate identifying the scale factor associated with the lowest error measurement, such as the lowest error measurement computed at block 38, and, as shown in block 40, selecting that scale factor and storing that scale factor for use with all subsequent frames associated with the particular adjacent cameras. In many example implementations, a one-time calculation of the scaling factor to be applied to one image with respect to a pair of adjacent images will be sufficient to result in an appearance of image elements in and around a seam area that is free or nearly free of visually perceptible errors and/or otherwise meets criteria associated with an acceptable appearance of a seam for numerous subsequent image frames captured by the cameras.

As shown in block 48, the apparatus 20 also includes means, such as the processor 22, memory 24, the communication interface 28, or the like, for determining whether there are any additional cameras in a camera array for which a scale factor has not been calculated. As shown in FIG. 3, some example implementations of process 30 operate such that, if the seam locations and scale factors for all adjacent images generated by a camera array have been calculated, the process 30 proceeds to block 50, which includes using and/or applying the selected seam location and scale factor for each set of images captured by the camera array.

The apparatus 20 includes means, such as the processor 22, memory 24, the communication interface 28, or the like, for applying the seam location and the scale factor to a plurality of subsequent image frames captured by the first camera and a plurality of subsequent image frames captured by the second camera. For example, and with reference to block 50 of FIG. 3, some example implementations involve storing the selected seam location and scale factor, such as in memory 24 or the like, and applying that location and scale factor to subsequently received images captured by the first camera and second camera. In some such implementations, no additional scaling of frames or error computation is done, thus reducing the time and processing resources necessary to determine a suitable seam location and scale factor. In some example implementations of block 50 of FIG. 3, if there are additional cameras for which a scale factor and/or seam location need to be established, process 30 includes returning from block 48 to block 34, and repeating the relevant steps for any such images. The apparatus 20 also includes means, such as the processor 22, memory 24, the communication interface 28, or the like, for doing so.

In contexts and/or example implementations where the seam location is not fixed, process 30 in FIG. 3 depicts transitioning from block 36 to block 42, which includes generating a plurality of scaled image frames by applying a plurality of scale factors to at least the image frame captured by one of the adjacent cameras. The apparatus 20 also includes means, such as the processor 22, memory 24, the communication interface 28, or the like, for generating a plurality of scaled image frames by applying a plurality of scale factors to the image frame captured by at least one of the first camera or the second camera. Any of the approaches to doing so contemplated herein with respect to block 38, other portions of FIG. 3, FIG. 4, or elsewhere, may be used in implementations of block 42.

Unlike example implementations that arise in contexts where the seam location between two images is fixed in advance, the computation of error associated with each scaled image need not be tied to a single region associated with the seam. The apparatus 20 also includes means, such as the processor 22, memory 24, the communication interface 28, or the like, for dividing the mutually overlapping portion of the fields of view of the image frame captured by the first camera and the image frame captured by the second camera into a plurality of overlapping sections. The apparatus 20 also includes means, such as the processor 22, memory 24, the communication interface 28, or the like, for computing an error measurement associated with each overlapping section of each scaled image frame from amongst the plurality of scaled image frames. For example, and as shown in block 44 of FIG. 3, a mutually overlapping portion of the images may be divided into a set of overlapping sections and an error associated with each section from among the set of overlapping sections, for each scaled image, may be calculated. In some example implementations of block 44, each overlapping section comprises a column at least one pixel wide, and the error associated with each overlapping section is computed by calculating the sum of the absolute difference between the pixels in each such column for the two adjacent images. However, as in example implementations of blocks 38 and 40, any approach to computing an error or other difference between overlapping portions of an image may be used in connection with example implementations of block 44. Moreover, while many example implementations contemplate divided overlapping sections in the form of columns, the sections may take on different shapes and configurations, including any of the seam shapes or configurations discussed or otherwise contemplated herein.

The apparatus 20 also includes means, such as the processor 22, memory 24, the communication interface 28, or the like, for identifying the section and the scale factor based upon the computed error measurement. For example, and as shown in block 46 of FIG. 3, this may include selecting the scale factor to apply and the section in which to locate the seam that results in the minimum computed error. However, other criteria may be applied to the selection of a seam location and/or scale factor, such as thresholds that, when met, cause the scaling and/or computation process to terminate, and/or other approaches directed to achieving an acceptable image, reducing the use of processing time and/or resources, or other considerations. Regardless of the criteria applied in selecting the seam location and scale factor, upon selection of the scale factor and seam location to be used with a particular set of adjacent images process 30 depicts transitioning, through the use of means included in with the apparatus 20, such as the processor 22, memory 24, the communication interface 28, or the like, to block 48′. Block 48′, like block 48 discussed above, includes determining whether there are any additional cameras in a camera array for which a scale factor and seam location have not been calculated. If no such cameras exist, process 30 depicts progressing to block 50. If there are such cameras for which a scale factor and seam location need to be calculated, process 30 may include returning back to block 34 and performing at least the actions discussed herein with respect to process 30.

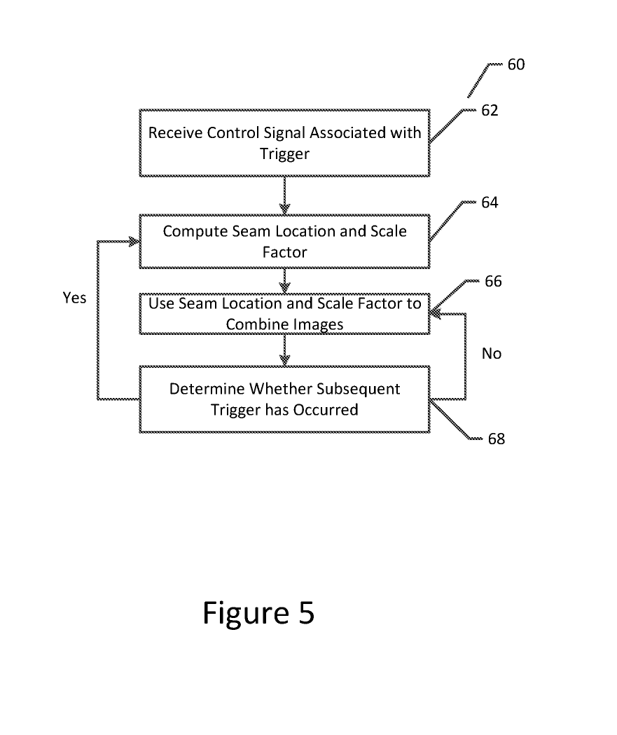

Referring now to FIG. 5, the operations performed by the apparatus 20 of FIG. 2 in accordance with an additional example embodiment to the present invention are depicted as a process flow 60. In this regard, the apparatus includes means, such as the processor 22, the memory 24, the communication interface 28 or the like, for receiving a control signal associated with a trigger for determining a second seam location and a second scale factor for a second image frame captured by the first camera and a second image frame captured by the second camera. For example, and as shown in FIG. 5, process 60 commences at block 62 with the receipt of a control signal associated with a trigger. In some example implementations, the trigger may be generated manually, such as by a command issued by a user of a viewing device or by a signal transmitted to the apparatus 20 via the communication interface 28 by an external source or actor. In some example implementations, the trigger may be generated automatically, such as in accordance with protocols involving the passage of time, changes of location of one or more individual cameras and/or the entire camera array, changes in content contained in one or more images, or in accordance with other criteria.

The apparatus also includes means, such as the processor 22, the memory 24, the communication interface 28 or the like, for, in response to receiving the control signal, determining the second seam location and the second scale factor for the second image frame captured by the first camera and the second image frame captured by the second camera. For example, and as depicted in block 64 of FIG. 5, some example implementations involve, upon receiving a control signal associated with a trigger, computing a second seam location and a second scale factor to be used when combining adjacent images. In some example implementations, the receipt of a control signal associated with a trigger will cause the determination of a seam location and/or a scale factor for the particular frames received at the time the trigger and/or the control signal associated with the trigger was received. For example, if a trigger, or its associated control signal are synchronized to a frame or otherwise received simultaneously or nearly simultaneously with a frame, the determination of a seam location and/or a scale factor performed in response to the receipt of a trigger and/or its associated control signal may be performed immediately on such frame or frames. However, other example implementations may involve a delay between the receipt of a trigger and/or its related control signal and the determination of a seam location and/or a scale factor in response to such receipt. For example, a trigger or a control signal associated with a control signal may be received asynchronously with one or more frames, such that an interval of time may pass between the receipt of a trigger or an associated control signal and the receipt of one or more frames for which a seam location and/or a scale factor may be determined. In some other example embodiments, additional operations may be performed by the apparatus in a period of time between the receipt of a trigger or its related control signal and a responsive determination of a seam location and/or a scale factor. Such additional operations may include, for example, additional processes to confirm receipt of the trigger and/or its related control signal, additional image processing, the implementation of predetermined delay, and/or any other operations or processes. Regardless of the timing involved with determining a seam location and/or a scale factor in response to the receipt of a trigger or its related control signal, any of the approaches to determining a seam location and/or scale factor discussed herein, including but not limited to those discussed with regards to process 30, FIG. 3, and FIG. 4, may be used in implementations of block 64, and in other implementations of determining the second seam location and the second scale factor for the second image frame captured by the first camera and the second image frame captured by the second camera.

The apparatus 20 includes also means, such as the processor 22, the memory 24, the communication interface 28 or the like, for applying the second seam location and the second scale factor to a second plurality of subsequent image frames captured by the first camera and a second plurality of subsequent image frames captured by the second camera. For example, as shown in FIG. 5, at block 66 and block 68, implementations of apparatus 20 operating in accordance with process 60 continue to use the second seam location and second scale factor when combining adjacent images pending the receipt of a control signal associated with a subsequent trigger. Any of the approaches to applying a seam location and a scale factor to a plurality of images, including but not limited to those discussed herein with respect to block 50 of FIG. 3, other portions of FIG. 3, FIG. 4, or elsewhere, may be used. Upon receipt of such a control signal, process 60 contemplates and depicts a return to block 64, where the seam location and scale factor may be recalculated in response to the subsequent trigger.

Implementations of process 60 may be particularly advantageous in situations where the position of a camera within an array and/or an entire camera array changes, such that a previously calculated seam location and/or scale factor may cease to be optimal or acceptable. Moreover in situations where the trigger may be generated by a viewer of a 360° video stream, the recalculation of the seam location and/or scale factor may be particularly beneficial where the user is focused on content at or near the seam location, such that the recalculation and/or relocation of the seam may improve the viewer's experience.

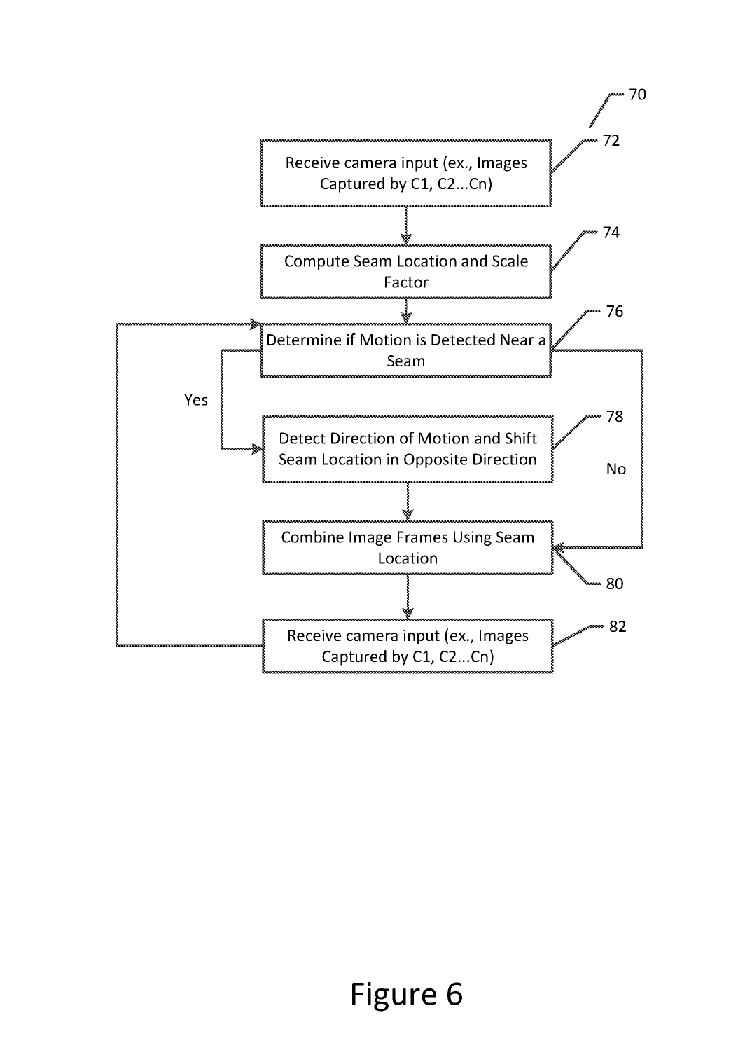

Referring now to FIG. 6, the operations performed by the apparatus 20 of FIG. 2 in accordance with an additional example embodiment to the present invention are depicted as a process flow 70. In this regard, the apparatus includes means, such as the processor 22, the memory 24, the communication interface 28 or the like, for detecting motion in the portion of an image near a seam between two adjacent images, determining a direction associated with the motion, and shifting the location of the seam in the opposite direction. In particular, the apparatus include means, such as the processor 22, the memory 24, the communication interface 28 or the like, for detecting a set of data associated with motion of an image element, wherein the image element is located within a predetermined distance of the seam location. For example, and as shown in FIG. 6, process 70 include blocks 72 and 74, which involve receiving a set of image frames that include adjacent images with overlapping portions, and computing a seam location and a scale factor to be applied for each such set of frames, respectively. Any of the example implementations discussed or contemplated herein, particularly those discussed in connection with process 30, FIG. 3, and/or FIG. 4, may be used in example implementations of blocks 72 and 74. As described previously herein, the apparatus 20 includes means, such as the processor 22, the memory 24, and the communication interface 28, or the like, for doing so. In some example implementations, such as those depicted, for example in block 76 of FIG. 6, motion may be detected in a region of an image may by detecting any set of data associated with motion in an image element, wherein the image element is located within a predetermined distance of a seam location. For example, object recognition protocols may be applied to all or part of an image to recognize objects depicted in an images that are typically associated with movement. In another example, data associated with an image element may be tracked across a plurality of frames to determine whether the element is moving. Regardless of the specific approach used to detect movement near a seam in an image, process 70 depicts, upon detecting motion near a seam, transitioning from block 76, where the motion is detected, to block 78.

The apparatus 20 may also include means, such as the processor 22, the memory 24, and the communication interface 28, or the like, for in response to detecting the set of data associated with motion of the image element, determining a direction associated with the motion and, in some instances, shifting the seam location in a direction opposite the direction associated with the motion. For example, and with reference to block 78 of FIG. 6, determining a direction associated with the motion and shifting the seam in the opposite direction may be implemented in an situation where a 360° image depicts a vehicle, person, animal, or other object moving from right to left across an image and continues moving in that direction in a region near the seam. As the moving object approaches the seam, the seam may be shifted from left to right, to avoid and/or reduce artifacts or other errors that may be visible as the moving object moves across the seam. In some example implementations, the magnitude of the shift of the seam may be predetermined. In other example implementations, the magnitude of the shift may be based at least in part on the apparent speed and/or size of the moving object, and/or other criteria associated with the seam and/or the moving object.

As shown in FIG. 6, some example implementations of process 70, contemplate, if motion is not detected near the seam, or after the seam has been shifted in response to the detection of the presence and direction of motion near the seam, the transitioning to block 80, which includes stitching video frames together using the seam location. In example implementations where the seam has been shifted in accordance with block 78, the new seam location may be used. In example implementations where no motion was detected in block 76, the previous seam location is used. Any approach to combining adjacent frames, including but not limited to those involving the determination and application of a scale factor and/or seam location described herein with respect to FIGS. 3, 4, and 5 may be used in example implementations of block 80. Process 70 further depicts a transition from block 80 to block 82, wherein another set of frames is received (similar to the receipt of frames in block 72, 32, and described elsewhere in this disclosure), and the subsequent return to block 76 to detect the presence or absence of motion near a seam.

As described above, FIGS. 3, 5, and 6 illustrate flowcharts of an apparatus 20, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an image frame captured by a first camera and an image frame captured by a second camera, wherein the first camera and the second camera have different fields of view, wherein the different fields of view have a mutually overlapping portion;
combining the image frame captured by the first camera and the image frame captured by the second camera into a composite image;
determining a seam location and a scale factor for the image frame captured by the first camera and the image frame captured by the second camera; and
applying the seam location and the scale factor to a plurality of subsequent image frames captured by the first camera and a plurality of subsequent image frames captured by the second camera.

2. A method according to claim 1, wherein determining a seam location and a scale factor comprises:
generating a plurality of scaled image frames by applying a plurality of scale factors to the image frame captured by at least one of the first camera or the second camera;
computing an error measurement associated with the seam location for each scaled image frame from amongst the plurality of scaled image frames; and
identifying the scale factor based upon the computed error measurement.

3. A method according to claim 1, wherein determining a seam location and a scale factor comprises:
generating a plurality of scaled image frames by applying a plurality of scale factors to the image frame captured by at least one of the first camera or the second camera;
dividing the mutually overlapping portion of the fields of view of the image frame captured by the first camera and the image frame captured by the second camera into a plurality of overlapping sections;
computing an error measurement associated with each overlapping section of each scaled image frame from amongst the plurality of scaled image frames; and
identifying the section and the scale factor based upon the computed error measurement.

4. A method according to claim 1, further comprising:
receiving a control signal associated with a trigger for determining a second seam location and a second scale factor for a second image frame captured by the first camera and a second image frame captured by the second camera; and
in response to receiving the control signal:
determining the second seam location and the second scale factor for the second image frame captured by the first camera and the second image frame captured by the second camera; and
applying the second seam location and the second scale factor to a second plurality of subsequent image frames captured by the first camera and a second plurality of subsequent image frames captured by the second camera.

5. A method according to claim 1, further comprising:
detecting a set of data associated with motion of an image element, wherein the image element is located within a predetermined distance of the seam location.

6. A method according to claim 5, further comprising:
in response to detecting the set of data associated with motion of the image element, determining a direction associated with the motion.

7. A method according to claim 6, further comprising shifting the seam location in a direction opposite the direction associated with the motion.

8. An apparatus comprising at least one processor and at least one memory storing computer program code, the at least one memory and the computer program code configured to, with the processor, cause the apparatus to at least:
receive an image frame captured by a first camera and an image frame captured by a second camera, wherein the first camera and the second camera have different fields of view, wherein the different fields of view have a mutually overlapping portion;
combine the image frame captured by the first camera and the image frame captured by the second camera into a composite image;
determine a seam location and a scale factor for the image frame captured by the first camera and the image frame captured by the second camera; and
apply the seam location and the scale factor to a plurality of subsequent image frames captured by the first camera and a plurality of subsequent image frames captured by the second camera.

9. An apparatus according to claim 8, wherein the at least one memory and the computer program code are configured to, with the processor, cause the apparatus to determine a seam location and a scale factor by:
generating a plurality of scaled image frames by applying a plurality of scale factors to the image frame captured by at least one of the first camera or the second camera;
computing an error measurement associated with the seam location for each scaled image frame from amongst the plurality of scaled image frames; and
identifying the scale factor based upon the computed error measurement.

10. An apparatus according to claim 8, wherein the at least one memory and the computer program code are configured to, with the processor, cause the apparatus to determine a seam location and a scale factor by:
generating a plurality of scaled image frames by applying a plurality of scale factors to the image frame captured by at least one of the first camera or the second camera;
dividing the mutually overlapping portion of the fields of view of the image frame captured by the first camera and the image frame captured by the second camera into a plurality of overlapping sections;
computing an error measurement associated with each overlapping section of each scaled image frame from amongst the plurality of scaled image frames; and
identifying the section and the scale factor based upon the computed error measurement.

11. An apparatus according to claim 8, wherein the at least one memory and the computer program code are configured to, with the processor, cause the apparatus to:
receive a control signal associated with a trigger for determining a second seam location and a second scale factor for a second image frame captured by the first camera and a second image frame captured by the second camera; and
in response to receiving the control signal:
determine the second seam location and the second scale factor for the second image frame captured by the first camera and the second image frame captured by the second camera; and
apply the second seam location and the second scale factor to a second plurality of subsequent image frames captured by the first camera and a second plurality of subsequent image frames captured by the second camera.

12. An apparatus according to claim 8, wherein the at least one memory and the computer program code are configured to, with the processor, cause the apparatus to:
detect a set of data associated with motion of an image element, wherein the image element is located within a predetermined distance of the seam location.

13. An apparatus according to claim 12, wherein the at least one memory and the computer program code are configured to, with the processor, cause the apparatus to:
in response to detecting the set of data associated with motion of the image element, determine a direction associated with the motion.

14. An apparatus according to claim 13, wherein the at least one memory and the computer program code are configured to, with the processor, cause the apparatus to shift the seam location in a direction opposite the direction associated with the motion.

15. A computer program product comprising at least one non-transitory computer-readable storage medium having computer-executable program code instruction stored therein, the computer-executable program code instructions comprising program code instructions configured to:
receive an image frame captured by a first camera and an image frame captured by a second camera, wherein the first camera and the second camera have different fields of view, wherein the different fields of view have a mutually overlapping portion;
combine the image frame captured by the first camera and the image frame captured by the second camera into a composite image;
determine a seam location and a scale factor for the image frame captured by the first camera and the image frame captured by the second camera; and
apply the seam location and the scale factor to a plurality of subsequent image frames captured by the first camera and a plurality of subsequent image frames captured by the second camera.

16. A computer program product according to according to claim 15, wherein the program code instructions configured to determine a seam location and a scale factor comprise program code instructions configured to:
generate a plurality of scaled image frames by applying a plurality of scale factors to the image frame captured by at least one of the first camera or the second camera;
compute an error measurement associated with the seam location for each scaled image frame from amongst the plurality of scaled image frames; and
identify the scale factor based upon the computed error measurement.

17. A computer program product according to according to claim 15, wherein the program code instructions configured to determine a seam location and a scale factor comprise program code instructions configured to:
generate a plurality of scaled image frames by applying a plurality of scale factors to the image frame captured by at least one of the first camera or the second camera;
divide the mutually overlapping portion of the fields of view of the image frame captured by the first camera and the image frame captured by the second camera into a plurality of overlapping sections;
compute an error measurement associated with each overlapping section of each scaled image frame from amongst the plurality of scaled image frames; and
identify the section and the scale factor based upon the computed error measurement.

18. A computer program product according to according to claim 15, wherein the computer-executable program code instructions further comprise program code instructions configured to:
receive a control signal associated with a trigger for determining a second seam location and a second scale factor for a second image frame captured by the first camera and a second image frame captured by the second camera; and
in response to receiving the control signal:
determine the second seam location and the second scale factor for the second image frame captured by the first camera and the second image frame captured by the second camera; and
apply the second seam location and the second scale factor to a second plurality of subsequent image frames captured by the first camera and a second plurality of subsequent image frames captured by the second camera.

19. A computer program product according to according to claim 15, wherein the computer-executable program code instructions further comprise program code instructions configured to:
detect a set of data associated with motion of an image element, wherein the image element is located within a predetermined distance of the seam location.

20. A computer program product according to according to claim 19, wherein the computer-executable program code instructions further comprise program code instructions configured to:
in response to detecting the set of data associated with motion of the image element, determine a direction associated with the motion; and
shift the seam location in a direction opposite the direction associated with the motion.
